(19) United States
(12) Patent Application Publication
(10) Pub. No.: US 2008/0094648 A1
(43) Pub. Date: Apr. 24, 2008

(54) Raw data processing apparatus and raw data processing method

(75) Inventor: Takayoshi KOJIMA, Azumino-shi (JP)

Correspondence Address: EDWARDS ANGELL PALMER & DODGE LLP, P.O. BOX 55874, BOSTON, MA, 02205, US

(73) Assignee: Seiko Epson Corporation, Tokyo (JP)

(21) Appl. No.: 11/977,489

(22) Filed: Oct. 24, 2007

(30) Foreign Application Priority Data
Oct. 24, 2006 (JP) 2006-289210

(51) Int. Cl. G06F 3/12

(52) U.S. Cl. 358/1.9

(57) ABSTRACT

A raw data processing apparatus is provided. In the apparatus, it is determined whether monochrome processing has been performed on data (color information) of a plurality of data read out from image data included in thumbnail data, screen nail data, or a simultaneous record JPEG file when an instruction to print raw data is input through an internal communication inter face 69. If it is determined that the monochrome processing has been performed on the data, an instruction is output to a printer unit 20 to perform development processing including monochrome processing of a multifunction printer 10 to generate JPEG-compressed image data and perform print processing based on the JPEG-compressed image data.

### BACKGROUND OF THE INVENTION

1. Field of the Invention

The present invention relates to a raw data processing apparatus and raw data processing method.

2. Description of the Related Art

Conventionally, digital cameras for performing sepia processing and gray scale processing on image data have been known. For example, Japanese Unexamined Patent Application Publication No. 2002-314930 discusses such a digital camera. To the digital camera, a printer is connected and a user operates a sepia/gray scale button of the printer to input a command to execute sepia processing or gray scale processing. When the digital camera receives image data to which the designated processing is to be performed, the digital camera executes the sepia processing or the gray scale processing on an image which has been represented using the image data, and sends the image-processed image data file to the printer. In receiving the processed image data file, the printer executes printing of the image data.

### SUMMARY OF THE INVENTION

When users take a picture using digital cameras which have a function to store undeveloped raw data captured by an image pickup device such as a CCD, the users can instruct the cameras to perform monochrome processing such as sepia processing, gray scale processing, or the like. Some of the digital cameras can store reduced image data such as thumbnail data or screen data in a raw file in addition to header information or raw data containing various information. When an instruction to print the raw data stored in the raw file is issued to printing devices, the printing devices perform development processing and monochrome processing of the raw data and execute the printing.

However, generally, different cameras uses their own raw data formats and the raw files may not include information about whether the user instructed to perform the monochrome processing at the time of shooting. Accordingly, the printing devices that execute the print processing of the raw data included in the raw file may not directly obtain the information about whether the user instructed the monochrome processing at the time of shooting from the raw file even if the printing devices can analyze the contents of the raw file at the time of development processing to be performed before the print processing. In such a case, even if the user wants the cameras to perform the monochrome processing, the printing devices may not perform the monochrome processing.

Accordingly, it is an object of the present invention to provide a raw data processing apparatus and raw data processing method which can perform own development processing including monochrome processing on raw data to which a user instructed to perform monochrome processing in a different apparatus.

In order to achieve at least a part of the above object, the present invention provides the following apparatus and method.

According to an aspect of the present invention, a raw data processing apparatus for processing raw data includes an output unit for performing a predetermined output processing;
a data readout unit for reading out the raw data and different development data generated by a different apparatus by performing development processing on the raw data from a storage unit storing the raw data and the different development data; and
a control unit for controlling the output unit, when a request to output the raw data is issued, that determines whether development processing including monochrome processing of the different apparatus has been performed on the readout different development data, and if the development processing including the monochrome processing of the different apparatus has been performed on the readout different development data, performs own development processing including monochrome processing on the readout raw data to generate own development data and performs the predetermined output processing based on the own development data.

According to the raw data processing apparatus, when an request to output raw data is issued, the output unit is controlled to determine whether development processing including monochrome processing of the different apparatus has been performed on the readout different development data. If it is determined that the development processing including the monochrome processing of the different apparatus has been performed on the readout development data, the output unit is controlled, to perform own development processing including monochrome processing on the readout raw data to generate own development data and perform the predetermined output processing based on the own development data. With the processing, it is possible to perform the own development processing including monochrome processing on the raw data to which a user has instructed to perform the monochrome processing in the different apparatus. The predetermined output processing includes print processing, display processing, and the like. The monochrome processing includes gray scale processing for representing an image using white, black, and gray, monotone processing for representing an image using gradation or tone of one chromatic color, and the like.

In the raw data processing apparatus, the different development data may be thumbnail data or screen nail data recorded in a file including the raw data. It is preferable to use the thumbnail data and the screen nail data as developed data because these data are usually stored together with raw data generated in imaging apparatuses, for example, a digital camera.

In the raw data processing apparatus, the different development data may be image data included in a simultaneous record file stored in the storage unit as a file different from the file including the raw data. Using the image data, when the simultaneous record file has been generated, the simultaneous record file can be effectively used.

In the raw data processing apparatus, the control unit may determines, in response to the request: to output the raw data, whether the development processing including the monochrome processing of the different apparatus has been performed on the readout different development data based on color information of each pixel in a part or whole of the different development data. This enables to accurately determine whether the monochrome processing of the different apparatus has been performed on the raw data requested to be output.

The raw data processing apparatus may include set value input unit to which uses can input a set value concerning the development processing including the monochrome processing of own apparatus. The control unit may perform the development processing including the monochrome processing of own apparatus on the readout raw data based on the set value. This enables the user to perform a desired development processing.

According to another aspect of the present invention, a raw data processing method for performing predetermined output processing on raw data using computer software includes (a) a step of determining whether development processing including monochrome processing of a different apparatus has been performed on different development data read out from a storage unit when a request to output the raw data is issued; and
(b) a step of generating own development data by performing development processing including own monochrome processing on the raw data read out from the storage unit and performing the output processing based on the own development data if it is determined that the development processing including the monochrome processing of the different apparatus has been performed on the readout development data in the step (a).

In the raw data processing method, when a request to output raw data is issued, it is determined whether development processing including monochrome processing of the different apparatus has been performed on different development data read out from storage unit. If it is determined that the development processing including the monochrome processing of the different apparatus has been performed on the readout development data, own development data is generated by performing own development processing including monochrome processing on the raw data read out from the storage unit and performing the output processing based on the own development data. According to the method, it is possible to perform the development processing including own monochrome processing on the raw data on which the user instructed to perform the monochrome processing in the different apparatus. The predetermined output processing includes print processing, display processing, and the like. The monochrome processing includes gray scale processing for representing an image using white, black, and gray, monotone processing for representing an image using gradation or tone of one chromatic color, and the like. In addition, it is possible to add a step for realizing advantages and functions obtained from each configuration provided in the above-described raw data processing apparatus.

According to still another aspect of the invention, the raw data processing method may be used by executing a program for executing each step with one or more computers. This program may be recorded on a computer-readable medium such as a hard disk, ROM, FD, CD, DVD, and the like. The program may be provided from a computer to another computer through a transmission medium such as a communication network like the Internet, and LAN, or, may be transmitted or received using any other unit. If the program is executed by a computer or computers in a distributed computing system, each step in the above-described raw data processing method can be executed. This enables to obtain similar advantages to those of the above-described raw data processing method.

### BRIEF DESCRIPTION OF THE DRAWINGS

FIG. 1 is an outline view and block diagram of a multifunction printer 10 according to an embodiment of the present invention,

FIG. 2 is an explanatory view of a file recorded in a memory card 42 according to an embodiment of the present invention,

FIG. 3 is an explanatory view of a raw file according to an embodiment of the present invention,

FIG. 4 is an explanatory view of a charge-coupled device (CCD) according to an embodiment of the present invention, and

FIG. 5 is a flowchart illustrating an exemplary raw data print processing routine according to an embodiment of the present invention.

### DESCRIPTION OF THE PREFERRED EMBODIMENTS

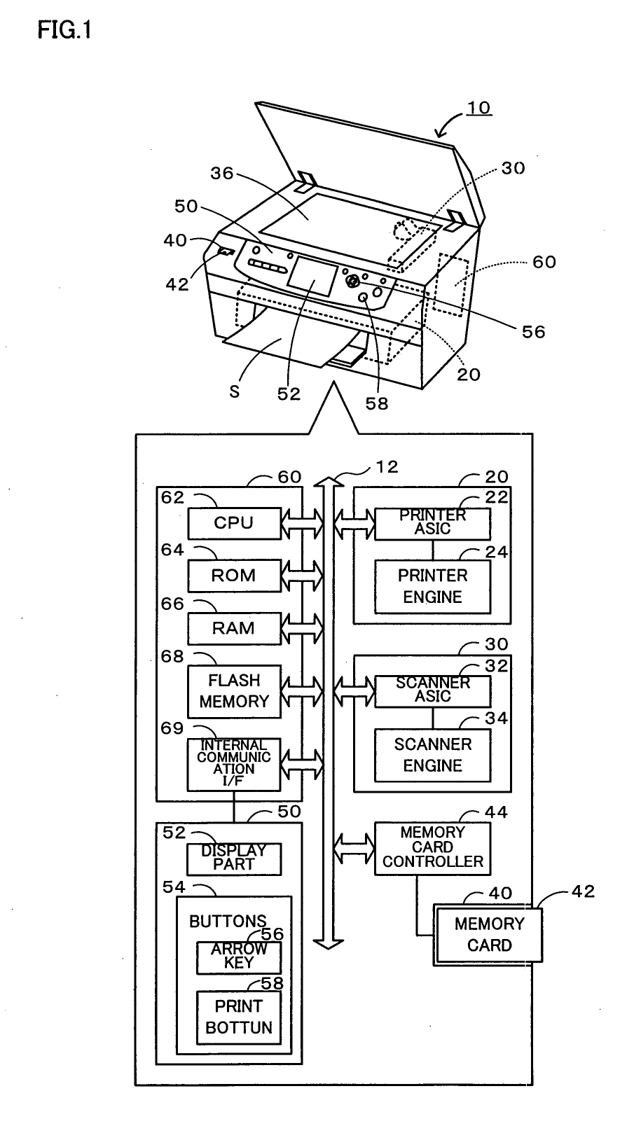

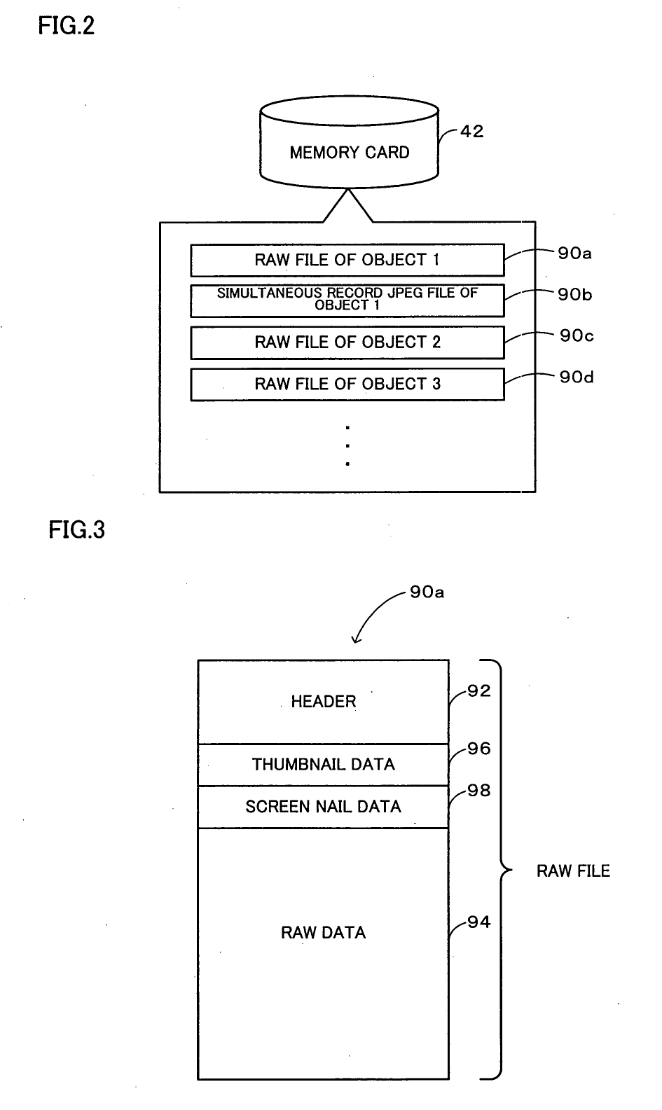

Now, embodiments of the present invention will be described with reference to attached drawings. FIG. 1 is an outline view and a block diagram illustrating aL schematic configuration of a multifunction printer 10 of a file processing apparatus according to an embodiment of the present invention, FIG. 2 is an explanatory view of a file stored in a memory card 42, and FIG. 3 is an explanatory view of a raw file 90.

The multifunction printer 10 according to the embodiment includes, as shown in FIG. 1, a printer unit 20 which executes printing on a print sheet S according to a print job, a scanner unit 30 which reads documents placed on a glass table 36, a memory card controller 44 which inputs and outputs data between a memory card 42 inserted into a memory card slot 40, an operation panel 50 which displays various information on a display part 52 and inputs instructions given by users through buttons 54, and a main controller 60 which controls an entire apparatus. The multifunction printer 10 can transmit and receive various control signals and data through a bus 12 between the printer unit 20, the scanner unit 30, the memory card controller 44, and the main controller 60.

The printer unit 20 includes a printer ASIC (Application Specific Integrated Circuit) 22 and a printer engine 24. The printer ASIC 22 is an integrated circuit to control the printer engine 24. In response to a print instruction issued from the main controller 60, the printer ASIC 22 controls the printer engine 24 to print an image on the print sheet S based on a print instruction target image file. The printer engine 24 is configured as a known inkjet color printer mechanism to perform printing by discharging ink from a print head onto a sheet.

The scanner unit 30 includes a scanner ASIC 32 and a scanner engine 34. The scanner ASIC 32 is an integrated circuit to control the scanner engine 34. In response to a scan instruction issued from the main controller 60, the scanner ASIC 32 controls the scanner engine 34 to read a document placed on the glass table 36 as image data. The scanner engine 34 is configured as a known image scanner, and includes a known color image sensor which separates light emitted toward the document and reflected into colors of red (R), green (G), and blue (B), and generates scan data.

The memory card controller 44 inputs and outputs data between the memory card 42 which is inserted into the memory card slot 40 provided adjacent to the operation panel 50. When the memory card 42 is connected to the memory card slot 40, the memory card controller 44 reads a file stored in the memory card 42 and transmits the file to the main controller 60, and inputs an instruction issued from the main controller 60 and writes data in the memory card 42 according to the instruction. Then, in the memory card 42, for example, as shown in FIG. 2, a raw file 90a which is generated by shooting an object 1 with a digital camera by a user, a simultaneous record JPEG file 90b which is a record concerning the object 1 simultaneously generated at the shooting, a raw file 90c which is generated by shooting an object 2, a raw file 90d which is generated by shooting an object 3, and the like are stored.

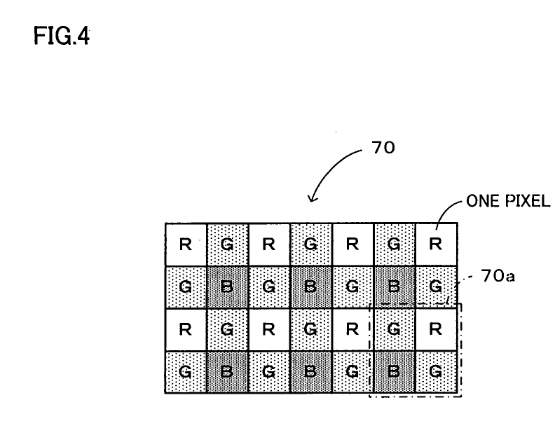

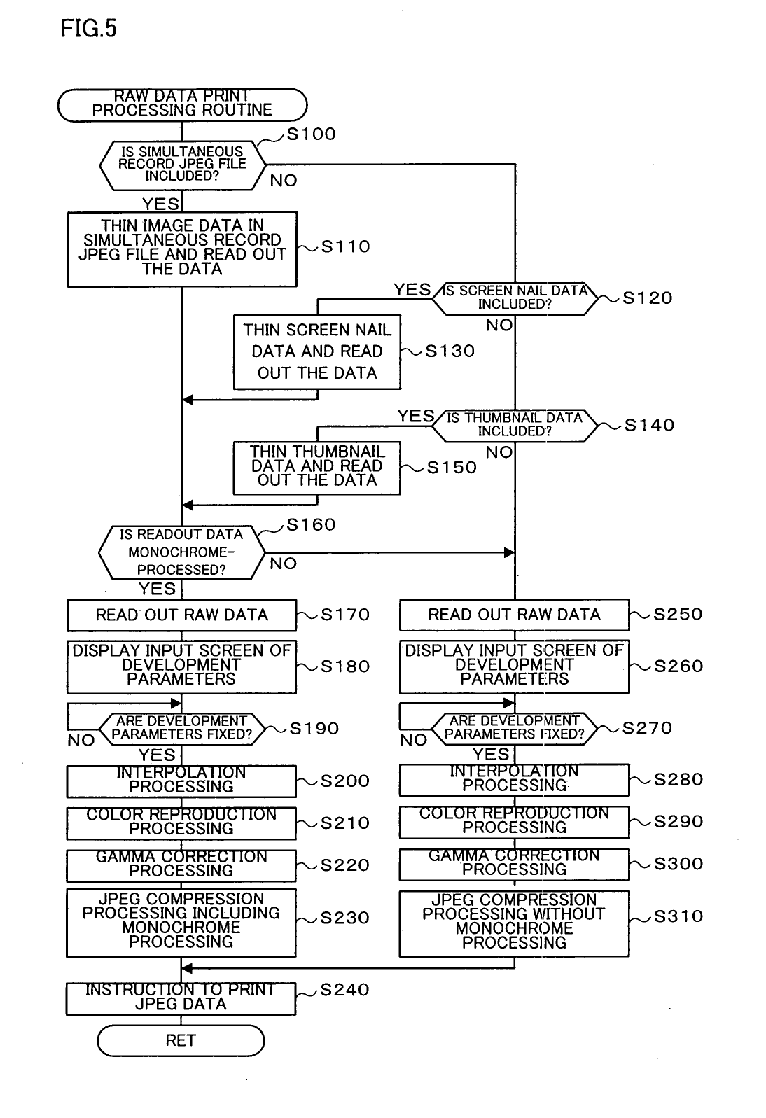

Now, the raw file 90a will be described with reference to FIG. 3. The raw file 90a is generated in a digital camera, for example, when an image is captured by the digital camera, and stored in the memory card 42 inserted into the digital camera. The raw file 90a includes a header 92 which contains various information and raw data 94 which is unprocessed data obtained by digitalizing an electric signal obtained from charge generated when an image pickup device such as a CCD and CMOS of the digital camera received light. Further, the raw file 90a includes thumbnail data 96 and screen nail data 98 which are reduced images generated by developing the raw data 94. Similarly, the other raw files can include the thumbnail data and the screen nail data. The header 92 is a region which contains information about the number of vertical pixels, the number of horizontal pixels, the size of one pixel of the raw data 94, whether thumbnail data and screen nail data exist, compression formats of the attached thumbnail data 96 and screen nail data 98, various development parameters, and the like. The header 92 can include information which indicates whether the user selected to perform a monochrome processing at the time of shooting. However, some cameras may not include the information because different digital cameras employ different formats for the raw file 90a. Accordingly, in the embodiment, it is assumed that the header 92 of the raw file 90a does not include the information which indicates whether the user instructed to perform the monochrome processing at the time of shooting. In the raw data 94, each one pixel has one of the R, G, B data. For example, in a case where the image pickup element is a color CCD, generally, as shown in FIG. 4, each element of a color CCD 70 used for a digital camera can identify different colors by covering a color filter of one of R, G, B on each CCD element. In the present case, on a window 70a of 2×2 pixels, one R and B, and two G are disposed. Accordingly, in the raw data 94, each pixel has data of one of R, G, B. The raw data 94 generally has a rich tone representation of R, G, B of 8 to 16 bits respectively, and the data is not compressed or losslessly compressed so that the data can be fully recovered even if the data has been compressed. The thumbnail data 96 is mainly generated as image data for displaying a plurality of image data on a display screen of a digital camera, and is obtained by developing the raw data 94 in the digital camera so that the data has a predetermined size of, for example, 160×120 pixels. Accordingly, if the user instructed to perform monochrome processing such as gray scale processing or sepia processing at the time of shooting, the color information of each pixel of the thumbnail data 96 represents a color generated after the monochrome processing is performed. The screen nail data 98 is generated as image data for displaying one image on the display screen of the digital camera. The screen nail data 98 is generated by developing the raw data 94 in the digital camera so that the data has a predetermined size greater than that of the thumbnail data 96, for example, 480×360 pixels. Accordingly, similarly to the thumbnail data 96, if the user instructed to perform monochrome processing at the time of shooting, the color information of each pixel of the screen nail data 98 represents a color generated after the monochrome processing is performed. When the thumbnail data 96 and the screen nail data 98 are generated, in the digital camera, the raw data is developed and a predetermined compression processing (in the embodiment, JPEG compression processing) is performed.

Now, the simultaneous record JPEG file 90b will be described. In shooting, if the user selected to store a JPEG file in addition to the above raw file and to perform the monochrome processing, a JPEG file is generated according to settings which are set by the user at the time of shooting, for example, a setting of the size of JPEG-compressed image data to be generated, and the generated file is stored in the memory card 42. The JPEG file is the simultaneous record JPEG file. Color information of each pixel in the image data contained in the simultaneous record JPEG file represents a color obtained after the monochrome processing is performed similarly to the above-described thumbnail data 96 and the screen nail data 98.

The thumbnail data 96 and the screen nail data 98 are usually JPEG compressed, and the image data contained in the simultaneous record JPEG file is the JPEG-compressed image data. Accordingly, the color information of each pixel of the image data is represented using a known YCbCr color system according to a JPEG compression standard. The JPEG-compressed image data to be generated in the step is generally generated by appropriately thinning the information contained in the raw data to reduce the data size. However, in addition to the process, an operation error in the computer can occur during the JPEG compression. Accordingly, it is not possible to completely reproduce the raw data from the JPEG-compressed image data.

The operation panel 50 includes a display part 52 and buttons 54. The display part 52 is a liquid crystal display, and used to display information about printing status, a print menu, an input screen of development parameters, image data to perform printing, and the like. The buttons 54 includes an arrow button 56 which is operated to select image data to be printed, to input the development parameters, and the like, a print button 58 which is pressed to print selected image data, a determination button (not shown) which is pressed to enter the development parameters, a power button (not shown) which is operated to turn on or off a power source, and the like. The user can input an instruction using the operation panel 50 through an internal communication interface 69 into the main controller 60.

The main controller 60 is configured as a microprocessor which includes a CPU 62 as a main part, and further includes a ROM 64 which stores various processing programs, data, tables, and the like, a RAM 66 which temporarily stores scan data, print data, and the like, a flash memory 68 which is electrically rewritable, and holds data even if the power is turned off, and the internal communication interface 69 which enables to communicate with the operation panel 50. These devices are connected so that the devices can transmit and receive a signal with each other through the bus 12. To the main controller 60, various operation signals and detection signals transmitted from the printer unit 20, the scanner unit 30, and the memory card controller 44 can be input, and operation signals which are generated in response to operation of the buttons 54 of the operation panel 50 can be input. Further, the main controller 60 can output an instruction to the memory card controller 44, the instruction to read the raw files 90a, 90c, 90d, or the JPEG file 90b from the memory card 42 and output the readout data to the main controller 60. Further, the main controller 60 can output an instruction to execute printing of developed data, for example, JPEG-compressed image data, to the printer unit 20. Further, the main controller 60 can output an instruction to the scanner unit 30 to read a document placed con the glass table 36 as image data according to a scan instruction of the buttons 54 of the operation panel 50, and can output and instruction to the operation panel 50 to control the display part 52.

Now, operation of the thus configured multifunction printer 10 according to the embodiment, particularly, operation in printing raw data which is included in a raw file stored in the memory card 42 will be described.

FIG. 5 is a flowchart illustrating an example of raw data print processing routine executed by the CPU 62 of the multifunction printer 10. The routine is stored in the ROM 64 of the multifunction printer 10. The routine is executed when the user selects a raw file stored in the memory card 42 as a file to be printed by operating the arrow key 56 of the operation panel 50 and presses the print button 58 of the operation panel 50 to input a print instruction for the raw file through the internal communication interface 69. In response to the execution of the routine, first, the CPU 62 of the multifunction printer 10 determines whether the above-described simultaneous record JPEG file which is simultaneously generated at the time the raw file selected as the file to be printed by the user is stored in the memory card 42 (step S100). With respect to whether the simultaneous record JPEG file corresponding to the raw file is stored in the memory card 42, for example, it can be determined by comparing each file name of each JPEG file from which the extension is removed stored in the memory card 42 with a file name of the raw file from which the extension is removed, and determining whether a JPEG file which has the same file name is stored in the memory card 42.

Then, in the step S100, if the CPU 62 determines that the simultaneous record JPEG file is stored in the memory card 42, data (color information) of a plurality of pixels in the JPEG-compressed image data included in the simultaneous record JPEG file is read (step S110). Then, in order to reduce the processing time, in the embodiment, the data is read out at every two lines in a vertical or horizontal direction of the image data. On the other hand, in step S100, if the CPU 62 determines that the simultaneous record JPEG file is not stored in the memory card 42, it is determined whether the above-described screen nail data is recorded in the raw file which is selected as the file to be printed by the user (step S120). Whether the screen nail data is recorded can be determined by referring to information recorded in a header of the raw file. If the screen nail data is recorded in the raw file, data (color information) of a plurality of pixels in the screen nail data is read out (step S130). Then, in order to reduce the processing time, in the embodiment, the data is read out at every two lines in a vertical or horizontal direction of the screen nail data. On the other hand, if the CPU 62 determines that the screen nail data is not recorded in the raw file, it is determined whether the above-described thumbnail data is recorded in the raw file which is selected as the file to be printed by the user (step S140). Whether the thumbnail data is recorded can be determined by referring to the information recorded in the header of the raw file. If the thumbnail data is recorded in the raw file, data (color information) of a plurality of pixels in the thumbnail data is read (step S150). Then, in order to reduce the processing time, in the embodiment, the data is read out at every two lines in a vertical or horizontal direction of the thumbnail data. Generally, the number of the pixels of the image data included in the simultaneous record JPEG file is greater than that of the screen nail data, and the number of the pixels of the screen nail data is greater than that of the thumbnail data. Accordingly, an amount of data read out from the image data included in the simultaneous record JPEG file is the greatest, and an amount of data read out from the thumbnail data is the smallest.

Then, the CPU 62 determines whether the monochrome processing is performed on the readout data (step S160) subsequently to step S150, the readout of the data about the plurality of the pixels in the JPEG-compressed image data included in the simultaneous record JPEG file in step S110, or the readout of the data about the plurality of the pixels in the screen nail data in step 130. The data (color information) read out in the step is represented using the YCbCr color system. It is determined that the monochrome processing is performed on the readout data if a standard deviation of color differences Cb of the whole readout data is smaller than a predetermined threshold Cbref, and a standard deviation of color differences Cr of the whole readout data is smaller than a predetermined threshold Crref. The thresholds Cbref and Crref are respectively set in advance by reading out a plurality of data from the image data generated by performing development processing including monochrome processing and based on the standard deviations of the color differences Cb and Cr of the whole data.

In step S160, if the CPU 62 determines that the monochrome processing is performed on the readout data, it is determined that development processing including the monochrome processing has been performed on the readout original data (the image data included in the simultaneous record JPEG file, or the like) by a different device. Then, the CPU 62 reads out the raw data recorded in the raw file (step S170), and controls the display part 52 to display an input screen of development parameters in each development processing, such as interpolation processing, color reproduction processing, gamma correction processing, and JPEG compression processing which will be described below (step S180). Development parameters (for example, the gamma correction values) in the development processing from the header of the raw file to the different device are read out to display the values as initial values. The user can change the development parameters using the arrow key 56, the determination button (not shown), or the like if necessary. Subsequently, it is determined whether the development parameters are fixed (step S190). In the embodiment, whether the development parameters are fixed is determined by detecting whether the user pressed the determination button (not shown) to which a function to fix all development parameters is allocated after appropriately changing the development parameters. Then, if the development parameters are not fixed, the CPU 62 stands by, and if the development parameters are fixed, the CPU 62 executes an interpolation processing on the readout raw data (step S200). The interpolation processing is performed since the data output from one CCD element included in the raw data has information about only one color element out of the color elements of R, G, B as described above. More specifically, as shown in FIG. 4, by referring to output data from CCD elements corresponding to adjoining other color elements, information about the adjoining other color elements which are not included in a pixel is provided. Thus, each pixel can obtain information about the color elements of R, G, B respectively. Then, a color reproduction processing is performed to match a spectral characteristic of a color filter which is covered on the CC D elements with a sensitivity characteristic of human eyes (step S210), and a gamma correction processing is performed to correct an output from the CCD or the like which has a nonlinear device characteristic (step S220).

Subsequently, the CPU 62 executes a JPEG compression processing which includes a monochrome processing (step S230). Before the JPEG compression processing is performed, generally, the CPU 62 converts values of R, G, B into values represented using the YCbCr color system by using a known conversion equation with respect to each pixel. In the embodiment, the converted values of luminance Y are employed as values which represent a gray scale of each monochrome-processed pixel. Further, for the values of color differences Cb and Cr, in place of the values of color differences Cb and Cr of each converted pixel, a center value (or, an average value can be used) of statistical distribution of the values of the color differences Cb and Cr of the plurality of data read out in step S110, step S130, or step S150 is employed to whole pixels to perform a monochrome processing which can be considered similar to that of the readout original data. Then, the CPU 62 outputs an instruction to the printer ASIC 22 to execute a print on a sheet S based on the JPEG-compressed image data (step S240), and ends the routine. In response to the print instruction, the printer ASIC 22 controls the printer engine 24 to execute the print on the sheet S based on the image data. In the embodiment, print conditions such as the size of sheets, the number of sheets to be printed, or the like used when the printer engine 24 executes the print on the sheet S are determined in advance (for example, the size of the sheet is a L-size photo paper, and the number of sheets to be printed is one).

In step S140, if it is determined that the thumbnail data is not included, that is, if the development-processed image is not included, the image generated when the raw data included in the raw file selected by the user as a file to be printed is developed in the different device, or, in step S160, if it is determined that the image data or the like included in the simultaneous record JPEG file is not monochrome, the CPU 62 reads out the raw data recorded in the raw file (step S250). Then, similarly to the processing in step S180, the CPU 62 controls the display part 52 to display an input screen of development parameters in the development processing (step S260). Subsequently, similarly to the processing in step S190, the CPU 62 determines whether the development parameters eLre fixed (step S270). If it is determined that the development parameters are not fixed, the CPU 62 stands by, and if the development parameters are fixed, performs an interpolation processing similar to that of step S200 on the readout raw data (step S280). Then, the CPU 62 executes a color reproduction processing similar to that in step S210 (step S290), and executes a gamma correction processing similar to that in step S220 (step S300). Subsequently, the CPU 62 executes a JPEG compression processing which does not include a monochrome processing (step S310). In the processing in step S310, different from the processing in step S230, the monochrome processing is not performed. That is, the data is considered as a color image. Then, the CPU 62 outputs an instruction to the printer ASIC 22 to execute the print on the sheet S based on the JPEG-compressed image data (step S240), and ends the routine (step S240). In response to the print instruction, the printer ASIC 22 controls the printer engine 24 to execute the print on the sheet S based on the image data.

Now, correspondence relationship between structural elements according to the embodiment and those according to the present invention will be described. The printer unit 20 according to the embodiment corresponds to output unit according to the present invention, the memory card controller 44 corresponds to data readout unit, the main controller 60 corresponds to control unit, and the buttons 54 correspond to set value input unit. In the embodiment, the description of the operation of the multifunction printer 10 also describes an example of a raw data processing method according to the present invention.

According to the multifunction printer 10 according to the embodiment as described in detail, a print instruction of raw data is input through the internal communication interface 69, and then, it is determined whether data (color information) of a plurality of pixels read out from image data included in thumbnail data, screen data, or a simultaneous record JPEG file are monochrome-processed. If the data is monochrome-processed, development processing including monochrome processing of the multifunction printer 10 is performed on the readout raw data to generate JPEG-compressed image data. Then, according to the JPEG-compressed image data, an instruction is output to the printer unit 20 to execute prLnt processing. According to the operation, the development processing including the monochrome processing of the multifunction printer 10 can be performed on the raw data on which the user instructed to perform the monochrome processing in a different device. Further, it is possible to use thumbnail data and screen nail data which are generated in storing raw data in other devices, for example, a digital camera, and can be stored together with the raw data. Further, if a simultaneous record JPEG file is generated, the simultaneous record JPEG file can be effectively used. Further, it is possible to accurately determine whether a monochrome processing has been performed by a different device on raw data to be print-processed since whether a monochrome processing has been performed is determined using color information such as the thumbnail data which was developed in the different device.

Needless to say, the present invention is not at all limited to the embodiment described above, and may be implemented in various embodiment as long as within the technical scope of the present invention.

In the above-described embodiment, as an example, whether image data is monochrome is determined using color differences Cb and Cr which are color information of the JPEG-compressed image data. However, color information other than the color differences Cb and Cr can be used if it is possible to determine whether the image data is monochrome. For example, values of light's three primary colors, RGB, can be used. In such a case, as conditions to enable to determine whether the data is monochrome, with respect to whole data (pixels) read out in step S110, step S130, or step S150, any other conditions can be used instead of the conditions that a standard deviation of the color difference Cb is smaller than a predetermined threshold Cbref, and a standard deviation of the color difference Cr is smaller than a predetermined threshold Crref. For example, the condition can be obtained that whole data (pixels) read out in step S110, step S130, or step S150 is converted from YCbCr into RGB to obtain values of R/G and B/G, and statistics are taken with respect to the obtained values. Then, using the obtained standard deviations, it is determined whether the standard deviations are smaller or equal to predetermined thresholds respectively. The predetermined thresholds can be respectively set in advance based on standard deviations obtained by reading out a plurality of data from image data generated by performing development processing including monochrome processing, and converting the whole readout data from YCbCr into RGB to obtain R/G and B/G values.

In the above-described embodiment, the data read out in step S110, step S130, or step S150 is read out at every two lines in the vertical or horizontal direction of the image data. However, if it is possible to read out data about a plurality of pixels, any other readout method can be used. For example, the data can be read out at every two pixels or randomly selected data of pixels can be read out. Moreover, data can be read out until an amount of the data comes to a same amount of data (for example, 1000 pixels) preliminary set within a range which does not exceed the number of pixels expected to be contained in thumbnail data. Moreover, the data can be read out until amounts of the data come to amounts of data set in advance for each image data included in thumbnail data, screen nail data, or simultaneous record JPEG file.

In the above-described embodiment, in order from the image data included in the JPEG file, the screen nail data, and the thumbnail data, whether the data is stored in the memory card 42 or recorded in the raw file is determined. At the time it is determined that one of the data is stored or recorded, the data (color information) about the plurality of pixels is read out from the data. However, the order of determining whether the data is stored in the memory card 42 or recorded in the raw file is not limited to the above, but for example, first, it can be determined whether the thumbnail data is recorded in the raw file, then, whether the screen nail data is recorded in the raw file, and finally, whether the image data included in the JPEG file is stored in the memory card 42 can be determined.

In the above-described embodiment, the monochrome processing is performed in the processing of the JPEG compression. However, the timing to perform the monochrome processing is not limited to the timing of the JPEG compression. For example, the monochrome processing can be performed when the color reproduction processing is performed or the gamma correction processing is performed.

In the above-described embodiment, the raw file and the simultaneous record JPEG file are read out from the memory card 42. However, these files can be read from any other medium which can record these files. For example, these files can be read out from the memory 66 which receives these files from a digital camera using infrared data communication and temporarily stores the received files. These files can also be read out from a memory in a digital camera connected to the printer using USB connection. Moreover, these files can be read out from the memory 66 which receives the files from a computer on a computer network, for example, the Internet, and temporarily stores the files. In such cases, the multifunction printer 10 can include an infrared data communication board, a USB controller, a network interface board, or the like to realize the infrared data communication, the USB connection, or the network connection.

In the above-described embodiment of the present invention, the multifunction printer 10 which outputs prints is applied and described, however, any other device which can output image data to display can also be applied. For example, the present invention can be applied to photo storage viewers or digital cameras.

In the above-described embodiment, the full color printer 10 which employs an inkjet type and uses ink as coloring agents is used. However, color laser printers which employ an electrophotographic type and use toner as coloring agents or color printers which employ a thermoelectric type and use ink ribbons as coloring agents can be used. Further, fax machines or copying machines can be used.

The present application claims the benefit of priority from Japanese Patent Application No. 2006-289210 filed on Oct. 24, 2006, the entire contents of which are incorporated herein by reference.

What is claimed is:

1. A raw data processing apparatus for processing raw data, the raw data processing apparatus comprising:
an output unit for performing a predetermined output processing;
a data readout unit for reading out the raw data and different development data generated by a different apparatus by performing development processing on the raw data from a storage unit storing the raw data and the different development data; and
a control unit for controlling the output unit, when a request to output the raw data is issued, that determines whether development processing including monochrome processing of the different apparatus has been performed on the readout different development data, and if the development processing including the monochrome processing of the different apparatus has been performed on the readout different development data, performs own development processing including monochrome processing on the readout raw data to generate own development data and performs the predetermined output processing based on the own development data.

2. The raw data processing apparatus according to claim 1, wherein the different development data is thumbnail data or screen nail data recorded in a file including the raw data.

3. The raw data processing apparatus according to claim 1, wherein the different development data is image data included in a simultaneous record file stored in the storage unit as a file different from the file including the raw data.

4. The raw data processing apparatus according to claim 1, wherein the control unit determines, in response to the request to output the raw data, whether the development processing including the monochrome processing of the different apparatus has been performed on the readout different development data based on color information of each pixel in a part or whole of the different development data.

5. The raw data processing apparatus according to claim 1, further comprising a set value input unit to which uses can input a set value concerning the development processing including the monochrome processing of the own apparatus,
wherein the control unit performs the development processing including the monochrome processing of the own apparatus on the readout raw data based on the set value.

6. The raw data processing apparatus according to claim 1, wherein the predetermined output processing is print processing or display processing.

7. A raw data processing method for performing predetermined output processing on raw data using computer software, the raw data processing method comprising:
(a) a step of determining whether development processing including monochrome processing of a different apparatus has been performed on different development data read out from a storage unit when a request to output the raw data is issued; and
(b) a step of generating own development data by performing development processing including own monochrome processing on the raw data read out from the storage unit and performing the output processing based on the own development data if it is determined that the development processing including the monochrome processing of the different apparatus has been performed on the readout development data in the step (a).
